(19) United States
(12) Patent Application Publication
(10) Pub. No.: US 2019/0009717 A1
(43) Pub. Date: Jan. 10, 2019

(54) VEHICLE APPROACH NOTIFICATION DEVICE

(71) Applicant: Panasonic Intellectual Property Management Co., Ltd., Osaka (JP)

(72) Inventors: SHINNOSUKE NAGASAWA, Osaka (JP); FUMIYASU KONNO, Osaka (JP); ICHIRO OHNO, Osaka (JP)

(21) Appl. No.: 16/068,141

(22) PCT Filed: Dec. 27, 2016
(86) PCT No.: PCT/JP2016/005230

§ 371 Date: Jul. 5, 2018

(30) Foreign Application Priority Data
Jan. 22, 2016 (JP) 2016-011140

(51) Int. Cl. B60Q 5/00; B60R 11/02; G10K 11/178; H04R 3/12

(52) U.S. Cl. CPC B60Q 5/008; H04R 3/12; G10K 11/178; B60R 11/0217

(57) ABSTRACT

A vehicle approach notification device that can output a warning sound that a discomfort feeling to be brought to an occupant is reduced is provided. The vehicle approach notification device includes a first speaker, a second speaker, and a sound source that outputs a signal corresponding to one sound for notifying about approach of a vehicle. The vehicle approach notification device further includes a first amplifier and a second amplifier that are connected in series to the first speaker and the second speaker, respectively, and amplifies the signal, and a filter that is connected in series to the first amplifier and modulates the signal. The first speaker outputs a sound different from a sound to be output from the second speaker.

### TECHNICAL FIELD

The present disclosure relates to a vehicle approach notification device that is mounted to a vehicle and outputs a warning sound for making a notification about approach of a vehicle to an outside.

### BACKGROUND ART

Because an electrically driven vehicle and a hybrid vehicle have a low noise, a pedestrian or the like hardly perceives approach of a vehicle at low speed traveling at which a road noise of the vehicle is small. For this reason, low-noise vehicles such as the electrically driven vehicle and the hybrid vehicle includes a vehicle approach notification device that generates a warning sound which is a continuous sound evoking a traveling state of the vehicle during traveling to warn a pedestrian or the like about approach of a vehicle (for example, see PTLs 1 and 2).

### CITATION LIST

### Patent Literature

PTL 1: Unexamined Japanese Patent Publication No. H10-290499

PTL 2: Unexamined Japanese Patent Publication No. H7-322403

### SUMMARY OF THE INVENTION

When such a vehicle approach notification device generates a warning sound outward from a vehicle, the warning sound penetrates the vehicle. The warning sound brings a discomfort feeling to an occupant in the vehicle.

An object of the present disclosure is, therefore, to provide a vehicle approach notification device that can output a warning sound that a discomfort feeling to be brought to an occupant is reduced.

The vehicle approach notification device according to one aspect of the present disclosure includes the following configuration. That is, the device includes a plurality of speakers, a sound source that outputs a signal corresponding to one sound for making a notification about approach of a vehicle, a plurality of amplifiers that is connected in series to the plurality of speakers, respectively, and amplifies the signal, and a filter that is connected in series to at least one of the plurality of amplifiers and modulates the signal. At least one of the plurality of speakers outputs a sound which is different from sounds to be output from the other speakers of the plurality of speakers.

Note that those comprehensive or specific aspects may be implemented by a system, a method, an integrated circuit, a computer program, or a computer-readable recording medium such as a compact disk read only memory (a CD-ROM), or may be implemented by any combination of the system, the method, the integrated circuit, the computer program, and the recording medium.

The invention of the present disclosure can provide a vehicle approach notification device that can output a warning sound that brings a less discomfort feeling to an occupant while necessary sound pressure is maintained.

### BRIEF DESCRIPTION OF DRAWINGS

FIG. 1 is a block diagram illustrating a configuration of a vehicle approach notification device according to an exemplary embodiment of the present disclosure.

FIG. 2 is a diagram illustrating one example of a vehicle mounted with the vehicle approach notification device according to the exemplary embodiment.

FIG. 3A is a pattern diagram of the vehicle mounted with the vehicle approach notification device according to the exemplary embodiment as viewed from above.

FIG. 3B is a pattern diagram of the vehicle mounted with the vehicle approach notification device according to the exemplary embodiment as viewed from front.

FIG. 4 is a flowchart illustrating an operation of the vehicle approach notification device according to the exemplary embodiment.

FIG. 5 is a block diagram of a vehicle approach notification device according to a first modification of the exemplary embodiment of the present disclosure.

FIG. 6 is a flowchart illustrating an operation of the vehicle approach notification device according to the first modification.

FIG. 7 is a block diagram of a vehicle approach notification device according to a second modification of the exemplary embodiment of the present disclosure.

FIG. 8A is a pattern diagram of the vehicle mounted with the vehicle approach notification device according to the second modification as viewed from above.

FIG. 8B is a pattern diagram of the vehicle mounted with the vehicle approach notification device according to the second modification as viewed from front.

### DESCRIPTION OF EMBODIMENT

### (Knowledge Underlying the Present Invention)

A conventional vehicle approach notification device includes a speaker that generates a warning sound, a sound source that outputs a signal corresponding to the warning sound, and an amplifier that amplifies the signal output from the sound source to output the amplified signal to the speaker.

A vehicle warning sound source described in PTL 1 includes a warning sound generator, a signal processor, a first speaker, and a second speaker. The warning sound generator generates a warning sound signal. The signal processor inputs an output from the warning sound generator. The first speaker is installed outside a vehicle interior and inputs an output from the warning sound generator. The second speaker is installed such that an acoustic radiation surface thereof and an acoustic radiation surface of the first speaker are disposed on opposite sides, and inputs an output from the signal processor. The signal processor executes a signal process on the warning sound signal so that a dipole directional characteristic is implemented for the warning sounds to be output from the first speaker and the second speaker. The dipole directional characteristic is such that a main axial direction of acoustic radiation faces a front of the vehicle and a direction where the acoustic radiation is the smallest faces an occupant.

Further, in a warning sound device for an electrically driven vehicle described in PTL 2, a speaker is disposed such that a warning sound is propagated outward from a vehicle. The warning sound is output by driving the speaker when the vehicle is in a traveling possible state. When a driving state of the vehicle changes, a sound volume and sound quality of the warning sound are changed in accordance with a change amount.

In such a manner, the warning sound is generated outward from the vehicle so that a pedestrian or the like can be notified about approach of the vehicle. However, the warning sound notifies the pedestrian about approach of the vehicle and simultaneously brings a discomfort feeling to the pedestrian. Further, since the warning sound penetrates a vehicle interior, the warning sound brings the discomfort feeling to not only the pedestrian but also an occupant in the vehicle.

As to the warning sound to be output from a low-noise vehicle such as the electrically driven vehicle and the hybrid vehicle, National Highway Traffic Safety Administration (NHTSA) of North America studies a regulation of a minimum sound pressure value. For example, the minimum sound pressure value is regulated for 8-frequency bands of ⅓ octave, and it is necessary to output the warning sound having at least the minimum sound pressure value when measurement is performed by a predetermined measurement method. Therefore, the sound pressure of the warning sound cannot be made to be smaller than the minimum sound pressure value. Therefore, a technique that outputs a warning sound having at least the minimum sound pressure value and reduces a discomfort feeling to be brought to an occupant is demanded.

In general, when a plurality of speakers is disposed and identical sounds are output from the speakers in order to output a warning sound having at least the minimum sound pressure value, acoustic energy is focused on a specific frequency and the sounds become noisy. As a result, a discomfort feeling to be brought to an occupant tends to be increased.

The following exemplary embodiment will describe a vehicle approach notification device that can output a warning sound that necessary sound pressure is maintained and a discomfort feeling to be brought to an occupant is re duce d.

The vehicle approach notification device according to one aspect of the present disclosure includes a plurality of speakers, a sound source that outputs a signal corresponding to one sound for notifying about approach of a vehicle, a plurality of amplifiers that is connected in series to the plurality of speakers, respectively, and amplifies the signal, and a filter that is connected in series to at least one of the plurality of amplifiers and modulates the signal. At least one of the plurality of speakers outputs a sound that is different from sounds to be output from the other speakers of the plurality of speakers.

As a result, since one sound (one warning sound) for notifying about approach of a vehicle output from the sound source is modulated by the filter, at least one speaker outputs a sound that is different from sounds to be output from the other speakers. Therefore, a discomfort feeling to be brought to an occupant of the vehicle can be reduced by providing a beat effect or a chorus effect, or eliminating a muffled state of the warning sound, for example.

Further, the filter may be an amplitude modulator that modulates an amplitude of a signal.

As a result, a sound volume (sound pressure) of the whole sound to be output from at least one speaker can be adjusted, and only a sound volume of a component (a frequency) of a discomfort sound can be adjusted. Therefore, muffled sounds to be output from the plurality of speakers (closed resonances) are eliminated so that the discomfort feeling to be brought to the occupant of the vehicle can be reduced.

Further, the filter may be a frequency modulator that modulates a frequency of a signal.

As a result, due to the frequency modulation, a frequency of a sound to be output from at least one speaker shifts from frequencies of sounds to be output from the other speakers. Therefore, since the beat effect or the chorus effect is produced in the sounds to be output from the plurality of speakers, the discomfort feeling to be brought to the occupant of the vehicle can be reduced.

Further, the filter may be a phase modulator that modulates a phase of a signal.

As a result, due to the phase modulation, a phase of a sound to be output from at least one speaker shifts from phases of sounds to be output from the other speakers. Therefore, the beat effect or the chorus effect is produced in the sounds to be output from the plurality of speakers. Further, when the phase of the sound to be output from at least one speaker shifts from the phases of the sounds to be output from the other speakers, positions where the sounds to be output from the plurality of speakers can be heard can be changed or cancelled each other. Therefore, the discomfort feeling to be brought to the occupant of the vehicle can be reduced.

Further, the filter may be a delay filter that delays output timing of a signal.

As a result, a phase of a sound to be output from at least one speaker is delayed from phases of sounds to be output from the other speakers. Therefore, since the chorus effect is produced in the sounds to be output from the plurality of speakers, the discomfort feeling to be brought to the occupant of the vehicle can be reduced.

Hereinafter, an exemplary embodiment of the present disclosure will be described with reference to the drawings. Note that the exemplary embodiment described below illustrates a specific example of the present disclosure. Numerical values, shapes, materials, constituent elements, arrangement positions and connection modes of the constituent elements, steps, and order of the steps illustrated in the following exemplary embodiment are merely examples, and therefore are not intended to limit the present invention. Furthermore, among the constituent elements in the following exemplary embodiments, constituent elements not recited in the independent claim indicating the broadest concept are described as optional constituent elements.

### EXEMPLARY EMBODIMENT

The vehicle approach notification device according to the present exemplary embodiment is configured such that a warning sound to be output from at least one of the plurality of speakers is different from warning sounds to be output from the other speakers. As a result, a discomfort feeling to be brought to the occupant when the occupant hears the warning sound can be re duce d.

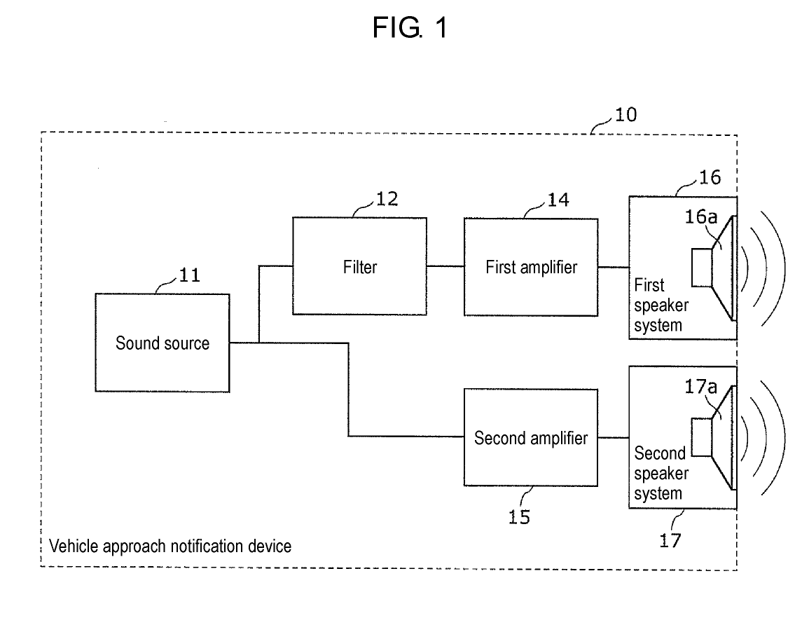

First, a configuration of the vehicle approach notification device according to the present exemplary embodiment will be described. FIG. 1 is a block diagram illustrating a configuration of vehicle approach notification device 10 according to the present exemplary embodiment.

As illustrated in FIG. 1, vehicle approach notification device 10 includes sound source 11, filter 12, first amplifier 14, second amplifier 15, first speaker system 16, and second speaker system 17. Further, first speaker system 16 includes first speaker 16a. Second speaker system 17 includes second speaker 17a. First speaker system 16 and second speaker system 17 may include speaker boxes to which first speaker 16a and second speaker 17a are mounted, respectively.

Sound source 11 generates a signal (an electric signal) corresponding to one warning sound for notifying the outside about the approach of vehicle 100. For example, the warning sound is an engine sound. In this case, sound source 11 frequently uses a pseudo-engine sound or an electronic sound as the warning sound, and the warning sound includes a low-pitched sound of 300 Hz to 500 Hz and a component having frequencies of 1 kHz to 3 kHz. The warning sound may be a simple sine-wave signal sound. Sound source 11 is connected to filter 12 and second amplifier 15. That is, the signal output from sound source 11 is input into filter 12 and second amplifier 15.

Filter 12 is connected between sound source 11 and first amplifier 14. The filter herein is a processor that executes a certain process on the signal to be output from sound source 11. Filter 12 may be, for example, an amplitude modulator, a frequency modulator, a phase modulator, a delay filter, or a pitch converter.

When filter 12 is the amplitude modulator, an amplitude of the signal input from sound source 11 to filter 12 is modulated by filter 12. As filter 12, for example, a parallel modulator, a ring modulator, or a modulator employing Hilbert transformation may be used. Further, as an example of the amplitude modulation, modulation may be performed by using a signal with a doubled amplitude or a direct-current signal, for example.

The amplitude modulation makes it possible to adjust a sound volume (sound pressure) of a whole warning sound to be output from first speaker 16a, and adjust only a sound volume of a discomfort component (a frequency) in the sound included in the warning sound. As a result, muffled sounds (closed resonances) of the warning sounds to be output from first speaker 16a and second speaker 17a are eliminated, and thus the discomfort feeling to be brought to an occupant of vehicle 100 can be reduced.

Further, when filter 12 is the frequency modulator, a frequency of the signal input from sound source 11 into filter 12 is modulated by filter 12. Further, when filter 12 is the phase modulator, a phase of the signal input from sound source 11 into filter 12 is modulated by filter 12. Since the phase modulator may be configured by disposing a differentiator before the frequency modulator, the phase modulator can be considered similarly to the frequency modulator. As filter 12, for example, a circuit employing a parameter method (a direct method) or an Armstrong method (an indirect method) may be used. Further, as an example of the frequency modulation, modulation may be performed by using a signal with a several-Hz higher frequency or a signal with a frequency of an octave higher tone.

The frequency modulation or the phase modulation causes a frequency or a phase of the warning sound to be output from first speaker 16a to shift from a frequency or a phase of the warning sound to be output from second speaker 17a. As a result, the beat effect or the chorus effect is produced in the warning sounds to be output from first speaker 16a and second speaker 17a. The beat effect is an effect such that a beat is generated by signals with different frequencies and a low-frequency signal generated by the beat produces a relaxation effect. Further, the chorus effect is an effect such that a fundamental tone of one sound source is blurred and expanded by temporally shifting the equal waveforms or shifting frequencies (shifting tones) and thus a relaxation feeling is brought. As a result, the warning sounds to be output from first speaker 16a and second speaker 17a can reduce a discomfort feeling to be brought to the occupant of vehicle 100.

Further, a position where the sounds to be output from the plurality of speakers are heard can be moved by shifting the phase of the warning sound to be output from first speaker 16a from the phase of the warning sound to be output from second speaker 17a. Further, the phase of the warning sound to be output from first speaker 16a is shifted by 180° from the phase of the warning sound to be output from second speaker 17a. As a result, the warning sounds to be output from first speaker 16a and second speaker 17a can be cancelled each other in a specific position. Therefore, the discomfort feeling that is caused by the warning sounds and is brought to the occupant of vehicle 100 can be reduced.

Further, when filter 12 is the delay filter, the phase of the warning sound to be output from first speaker 16a is delayed from the phase of the warning sound to be output from second speaker 17a. As a result, the chorus effect is produced in the warning sounds to be output from first speaker 16a and second speaker 17a. Therefore, the warning sounds to be output from first speaker 16a and second speaker 17a can reduce the discomfort feeling to be brought to the occupant of vehicle 100.

Further, when filter 12 is the pitch converter, similarly to the above-described frequency modulation, the frequency or the phase of the warning sound to be output from first speaker 16a shifts from the frequency or the phase of the warning sound to be output from second speaker 17a. As a result, the beat effect or the chorus effect is produced in the warning sounds to be output from first speaker 16a and second speaker 17a. Therefore, the warning sounds to be output from first speaker 16a and second speaker 17a can reduce the discomfort feeling to be brought to the occupant of vehicle 100.

The following will describe the case where filter 12 is the amplitude modulator as an example.

First amplifier 14 is connected between filter 12 and first speaker system 16. First amplifier 14 amplifies the signal to be output from filter 12 at a predetermined amplification degree so as to output the amplified signal to first speaker system 16.

Second amplifier 15 is connected between sound source 11 and second speaker system 17. Second amplifier 15 amplifies the signal to be output from sound source 11 at a predetermined amplification degree so as to output the amplified signal to second speaker system 17. The amplification degree at this time may be equal to or different from the amplification degree of first amplifier 14.

First amplifier 14 and second amplifier 15 may be analog amplifiers or digital amplifiers.

First speaker 16a and second speaker 17a output warning sounds for notifying about approach of a vehicle to the outside. First speaker 16a and second speaker 17a have a function of converting an electric signal into a mechanical vibration, and output the warning sounds of sound pressure based on the electric signal. First speaker 16a outputs a warning sound corresponding to the signal output from first amplifier 14. Second speaker 17a outputs a warning sound corresponding to the signal output from second amplifier 15. As described above, the warning sound that is different from the warning sound output from second speaker 17a is output from first speaker 16a.

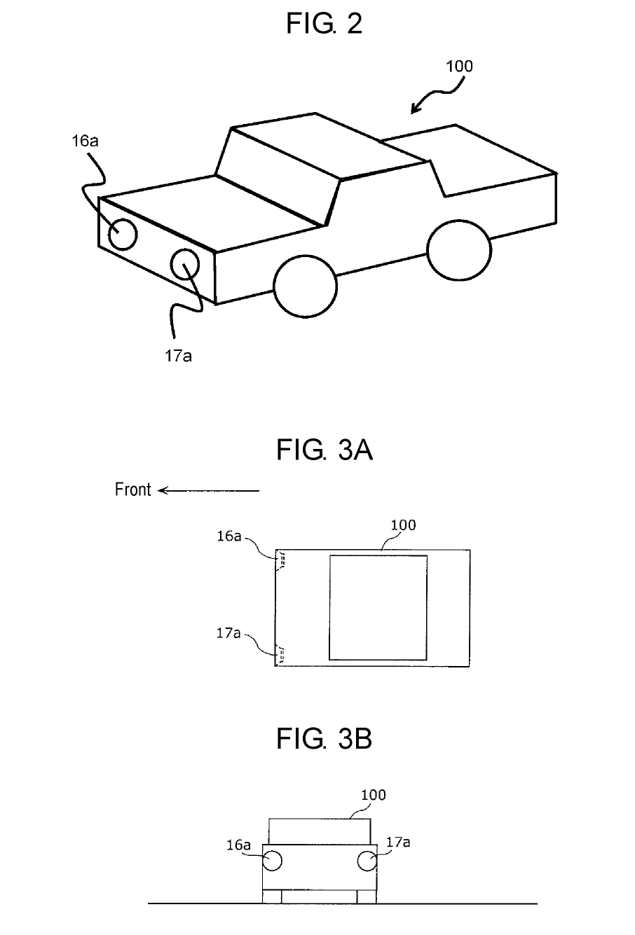

FIG. 2 is a diagram illustrating one example of the vehicle mounted with the vehicle approach notification device according to the present exemplary embodiment. FIG. 3A is a pattern diagram of the vehicle mounted with the vehicle approach notification device according to the present exemplary embodiment as viewed from above. FIG. 3B is a pattern diagram of the vehicle mounted with the vehicle approach notification device according to the present exemplary embodiment as viewed from front.

In vehicle approach notification device 10, the warning sounds to be output from first speaker 16a and second speaker 17a are generated toward a pedestrian outside the vehicle. For this reason, first speaker 16a and second speaker 17a are installed outside the vehicle. Specifically, as illustrated in

FIG. 2, first speaker 16a and second speaker 17a are disposed on two places on the front of vehicle 100 at a predetermined interval. At this time, as illustrated in FIG. 3A and FIG. 3B, main axial directions of acoustic radiation of first speaker 16a and second speaker 17a face forward with respect to vehicle 100. As a result, directions where the acoustic radiation of first speaker 16a and second speaker 17a is the least face toward the occupant of vehicle 100. For this reason, the warning sounds generated from first speaker 16a and second speaker 17a are hard to reach the occupant.

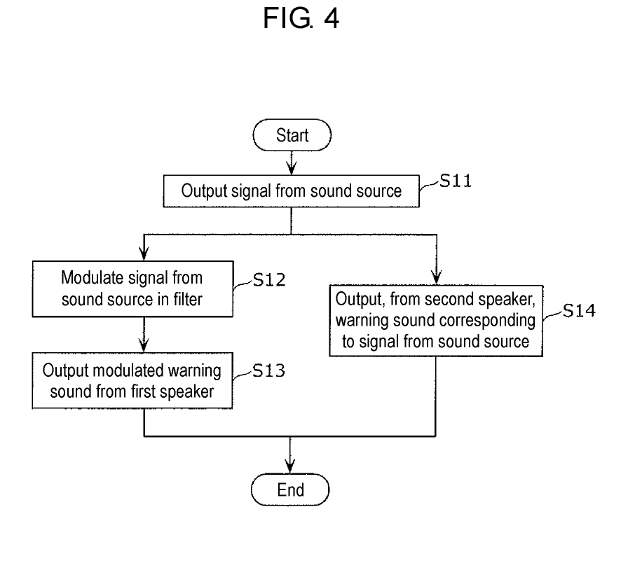

Further, vehicle approach notification device 10 performs the following operation so as to output a warning sound that the discomfort feeling to be brought to the occupant is reduced. FIG. 4 is a flowchart illustrating the operation of vehicle approach notification device 10 according to the present exemplary embodiment.

As illustrated in FIG. 4, in vehicle approach notification device 10, sound source 11 outputs a signal corresponding to a warning sound (step S11). This signal is input into filter 12 and is modulated by filter 12. Herein, since filter 12 is the amplitude modulator, an amplitude of the signal is modulated (step S12). The signal modulated by filter 12 is output from filter 12 to first amplifier 14. Thereafter, the signal output from filter 12 to first amplifier 14 is amplified by first amplifier 14 and is output to first speaker system 16. In first speaker system 16, then, first speaker 16a converts the signal amplified by first amplifier 14 (the electric signal) into a mechanical vibration. As a result, first speaker 16a outputs a warning sound (step S13).

Further, the signal corresponding to the warning sound output from sound source 11 is input into second amplifier 15. Second amplifier 15 amplifies the input signal and outputs the amplified signal to second speaker system 17. Thereafter, in second speaker system 17, second speaker 17a converts the signal amplified by second amplifier 15 (the electric signal) into a mechanical vibration. As a result, second speaker 17a outputs a warning sound (step S14).

Herein, since the warning sound output from first speaker 16a is modulated by filter 12, this warning sound is different from the warning sound output from second speaker 17a. Therefore, the discomfort feeling to be brought by a warning sound to the occupant of vehicle 100 can be reduced by providing the beat effect or the chorus effect, or eliminating the muffled state of the warning sound, for example.

In vehicle approach notification device 10 according to the present exemplary embodiment, when filter 12 is used, one signal corresponding to a warning sound output from the sound source is modulated by filter 12. As a result, the warning sounds to be output from first speaker 16a and second speaker 17a are different from each other. Therefore, vehicle approach notification device 10 provides the beat effect or the chorus effect, or eliminates the muffled state of a warning sound, for example, to be capable of outputting warning sounds that the discomfort feeling to be brought to the occupant is re duce d.

In the above-described embodiment, filter 12 is connected between sound source 11 and first amplifier 14, but filter 12 may be connected between first amplifier 14 and first speaker 16a. In this case, first amplifier 14 and second amplifier 15 may be configured by one common amplifier.

### (First Modification)

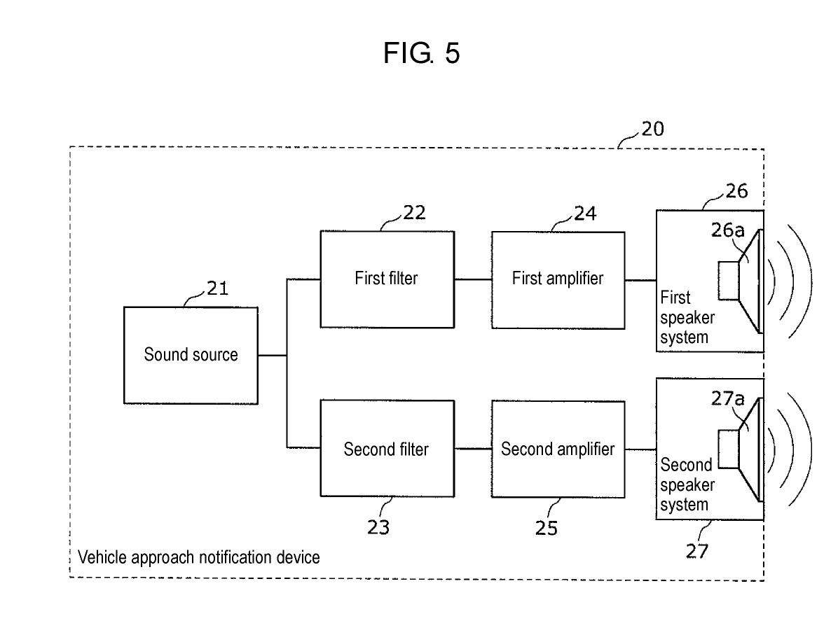

A first modification of the exemplary embodiment will be described below. FIG. 5 is a block diagram of the vehicle approach notification device according to the present modification.

Vehicle approach notification device 20 according to the present modification is different from vehicle approach notification device 10 according to the exemplary embodiment in that vehicle approach notification device 20 has second filter 23.

As illustrated in FIG. 5, vehicle approach notification device 20 according to the present modification includes sound source 21, first filter 22, second filter 23, first amplifier 24, second amplifier 25, first speaker system 26, and second speaker system 27.

First filter 22 is similar to filter 12 in vehicle approach notification device 10 according to the exemplary embodiment described above. Further, sound source 21, first amplifier 24, second amplifier 25, first speaker system 26, second speaker system 27, first speaker 26a, and second speaker 27a are similar to sound source 11, first amplifier 14, second amplifier 15, first speaker system 16, second speaker system 17, first speaker 16a, and second speaker 17a in vehicle approach notification device 10 according to the exemplary embodiment described above. Therefore, detailed description thereof will be omitted.

Second filter 23 may be, for example, an amplitude modulator, a frequency modulator, a phase modulator, a delay filter, or a pitch converter similarly to first filter 22. A type of second filter 23 may be the same as or different from a type of first filter 22. When the type of second filter 23 is made to be the same as the type of first filter 22, different conditions may be set for first filter 22 and second filter 23 such that different warning sounds are output from first speaker 26a and second speaker 27a.

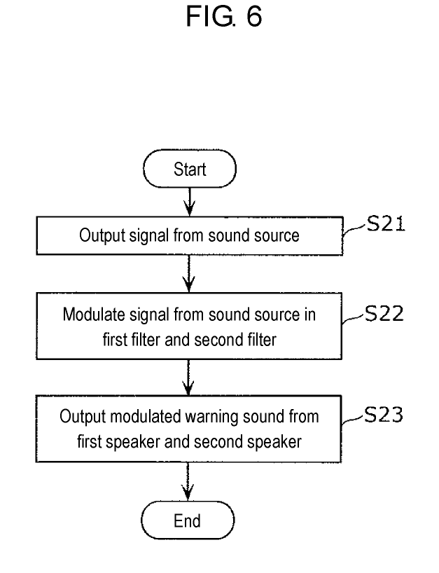

An operation of vehicle approach notification device 20 will be described below. FIG. 6 is a flowchart illustrating the operation of the vehicle approach notification device according to the present modification.

As illustrated in FIG. 6, in vehicle approach notification device 20, sound source 21 outputs a signal (step S21). This signal is input into first filter 22 and second filter 23 and is modulated by first filter 22 and second filter 23 (step S22). Herein, since first filter 22 and second filter 23 are filters that perform amplitude modulation, they modulate the signal with different amplitudes. As a result, signals to be output from first filter 22 and second filter 23 are different from each other.

The signals modulated by first filter 22 and second filter 23 are then output from first filter 22 and second filter 23 to first amplifier 24 and second amplifier 25, respectively.

The signal output from first filter 22 to first amplifier 24 is then amplified by first amplifier 24 and is output to first speaker system 26. Thereafter, in first speaker system 26, first speaker 26a converts the signal (the electric signal) amplified by first amplifier 24 into a mechanical vibration. As a result, a warning sound is output from first speaker 26a.

Further, the signal output from second filter 23 to second amplifier 25 is amplified by second amplifier 25 and is output to second speaker system 27. Thereafter, in second speaker system 27, second speaker 27a converts the signal amplified by second amplifier 25 into a mechanical vibration. As a result, a warning sound is output from second speaker 27a (step S23).

Herein, the warning sound output from first speaker 26a and the warning sound output from second speaker 27a are modulated by first filter 22 and second filter 23, respectively. For this reason, the warning sound output form first speaker 26a is different from the warning sound output from second speaker 27a. Therefore, the discomfort feeling to be brought by a warning sound to the occupant of vehicle 100 can be reduced by providing the beat effect or the chorus effect, or eliminating the muffled state of the warning sound, for example.

In the above-described modification, vehicle approach notification device 20 includes first filter 22 and second filter 23 that are filters for performing amplitude modulation. However, for example, first filter 22 may be a filter that performs amplitude modulation, and second filter 23 may be a filter that performs frequency modulation. As a result, since different signals are output from first filter 22 and second filter 23, first speaker 26a and second speaker 27a output different warning sounds. Therefore, the discomfort feeling to be brought by a warning sound to the occupant of vehicle 100 can be reduced by providing the beat effect or the chorus effect, or eliminating the muffled state of the warning sound, for example. The same is true on a case where first filter 22 and second filter 23 are filters that perform other types of signal conversion.

In vehicle approach notification device 20 according to the present modification, one signal corresponding to the warning sound output from sound source 21 is modulated differently by first filter 22 and second filter 23. For this reason, the warning sounds to be output from first speaker 26a and second speaker 27a, respectively, are different from each other. As a result, vehicle approach notification device 10 can output a warning sound that the discomfort feeling to be brought to the occupant is reduced.

### (Second Modification)

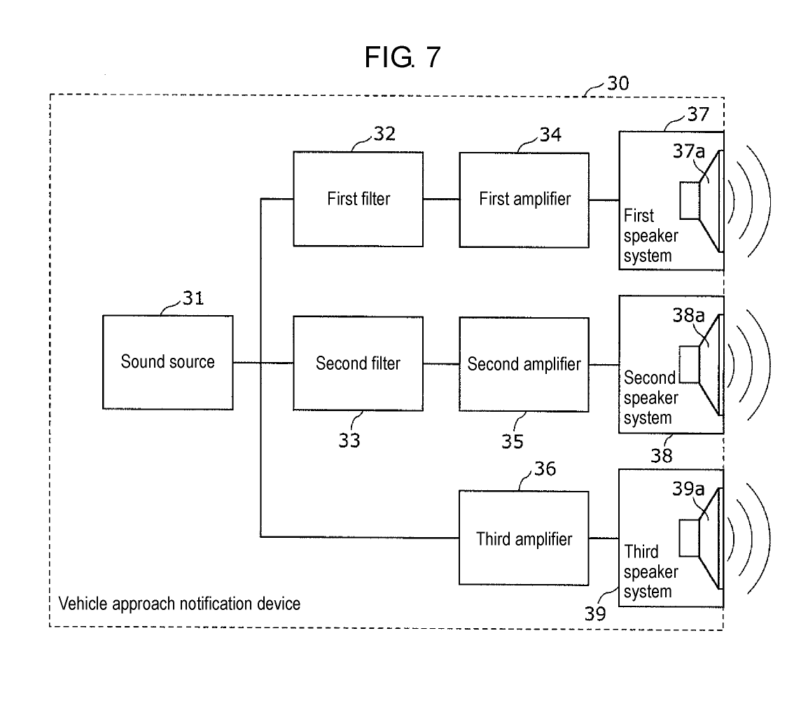

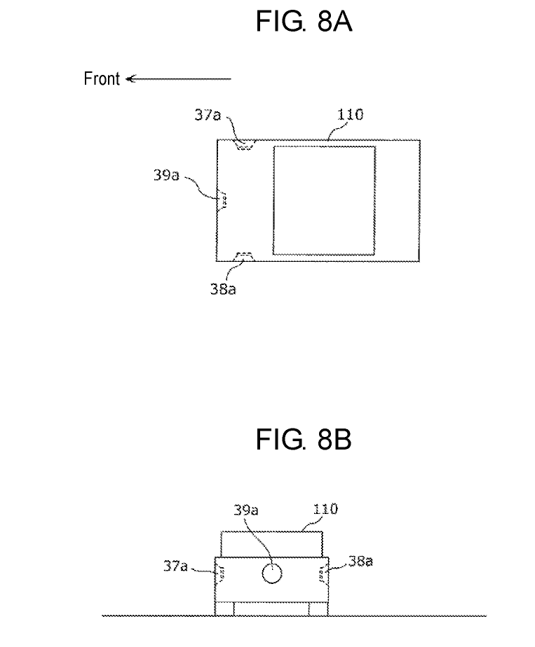

A second modification of the exemplary embodiment will be described below. FIG. 7 is a block diagram of the vehicle approach notification device according to the present modification. FIG. 8A is a pattern diagram of the vehicle mounted with the vehicle approach notification device according to the present modification as viewed from above. FIG. 8B is a pattern diagram of the vehicle mounted with the vehicle approach notification device according to the present modification as viewed from front.

Vehicle approach notification device 30 according to the present modification is different from vehicle approach notification device 20 according to the first modification in that vehicle approach notification device 30 includes third amplifier 36, third speaker system 39, and third speaker 39a.

As illustrated in FIG. 7, vehicle approach notification device 30 according to the present modification includes sound source 31, first filter 32, second filter 33, first amplifier 34, second amplifier 35, third amplifier 36, first speaker system 37, second speaker system 38, and third speaker system 39.

Third amplifier 36, third speaker system 39, and third speaker 39a are similar to second amplifier 15, second speaker system 17, and second speaker 17a in vehicle approach notification device 10 according to the exemplary embodiment described above. Further, sound source 31, first filter 32, second filter 33, first amplifier 34, second amplifier 35, first speaker system 37, second speaker system 38, first speaker 37a, and second speaker 38a are similar to sound source 21, first filter 22, second filter 23, first amplifier 24, second amplifier 25, first speaker system 26, second speaker system 27, first speaker 26a, and second speaker 27a in vehicle approach notification device 20 according to the first modification described above. Therefore, detailed description thereof will be omitted.

As described above, in vehicle approach notification device 30, first filter 32 is connected between sound source 31 and first speaker 37a, and second filter 33 is connected between sound source 31 and second speaker 38a, but no filter is connected only to third speaker 39a. Herein, a type of second filter 33 may be equal to or different from a type of first filter 32.

Herein, when the type of second filter 33 is equal to the type of first filter 32, and a signal from sound source 31 is modulated under the same condition, the same warning sounds are output from first speaker 37a and second speaker 38a. In this case, the warning sounds to be output from first speaker 37a and second speaker 38a are different from the warning sound to be output from third speaker 39a. Therefore, the discomfort feeling to be brought by the warning sound to the occupant of vehicle 110 can be reduced by providing the beat effect or the chorus effect, or eliminating the muffled state of the warning sound, for example.

At this time, as illustrated in FIG. 8A and FIG. 8B, third speaker 39a to which no filter is connected may be disposed at a center on the front of vehicle 110. First speaker 37a to which first filter 32 is connected and second speaker 38a to which second filter 33 is connected may be disposed on opposite sides of vehicle 110. As a result, the warning sound output from first speaker 37a is different from the warning sound output from third speaker 39a, and the warning sound output from second speaker 38a is different from the warning sound output from third speaker 39a. Therefore, the discomfort feeling to be brought by the warning sound to the occupant of the vehicle 110 can be efficiently reduced.

A type of second filter 33 may be different from a type of first filter 32. When the type of second filter 33 is different from the type of first filter 32, different warning sounds are output from first speaker 37a and second speaker 38a. Further, even when the type of second filter 33 is the same as the type of first filter 32, if a signal from sound source 31 is modulated under different condition, different warning sounds are output from first speaker 37a and second speaker 38a.

As a result, the warning sound output from first speaker 37a, the warning sound output from second speaker 38a, and the warning sound output from third speaker 39a are different from each other. Therefore, the discomfort feeling to be brought by the warning sound to the occupant of vehicle 110 can be efficiently reduced by providing the beat effect or the chorus effect, or eliminating the muffled state of the warning sound, for example.

The filter may be connected to all the three speakers including first speaker 37a, second speaker 38a, and third speaker 39a, or to two speakers or only one speaker. When the filter is connected only to one speaker, a speaker to which the filter is connected may be disposed at a center on the front of the vehicle, and the other speakers may be disposed on opposite sides of the vehicle. As a result, since the signal modulated by the filter is used for only the warning sound to be output from the speaker disposed at the center on the front of the vehicle, the warning sound to be output from the speaker disposed at the center on the front of the vehicle can be different from the warning sounds to be output from the sides of the vehicle. Therefore, the discomfort feeling to be brought by the warning sound to the occupant of the vehicle 110 can be efficiently reduced.

Further, first filter 32 and second filter 33 may be connected between sound source 31 and first amplifier 34 and between sound source 31 and second amplifier 35, respectively, or may be connected between first amplifier 34 and first speaker 37a and between second amplifier 35 and second speaker 38a, respectively. Further, first amplifier 34, second amplifier 35, and third amplifier 36 may be configured by a common amplifier or different amplifiers.

Further, disposition of the speakers is not limited to the above-described exemplary embodiment and the modifications. Therefore, four or more speakers may be disposed and connected to filters in any manner.

The vehicle approach notification device according to the exemplary embodiment and the modifications of the present invention has been described above. However, the present invention is not limited to the exemplary embodiment and the modifications.

At least a part of the constituent elements of the vehicle approach notification device according to the exemplary embodiment may be implemented as a large-scale integration (LSI) circuit. Each constituent element may individually be integrated into one chip, or some or all of the constituent elements may be integrated into one chip.

The circuit integration is not limited to the LSI, and may be achieved by a dedicated circuit or a general-purpose processor. A field programmable gate array (FPGA) in which programming can be performed after LSI fabrication or a reconfigurable processor that can reconfigure connections and settings of circuit cells in the LSI may also be used.

That is, in the above-described exemplary embodiment, the constituent elements may be implemented in dedicated hardware or with execution of software programs individually suitable for those constituent elements. The constituent elements may be implemented by a program execution section, such as a CPU or a processor, reading and executing software programs stored in a recording medium, such as a hard disk or a semiconductor memory.

All the numerals described above are used only for the specifically illustration of the present invention, but the present invention is not limited to the illustrated numerals.

Further, the division of the functional block in the block diagram is only by way of example, and a plurality of functional blocks may be implemented as one functional block, one functional block may be divided into the plurality of functional blocks, or a part of the functions may be transferred to another functional block. The functions of the plurality of functional blocks having similar functions may be processed in parallel or in a time-sharing manner by single piece of hardware or software.

The procedure to perform the plurality of steps indicated by the flowchart or the like described above is used only for the specific illustration of the present invention, and the plurality of steps may be performed in a procedure other than the above procedure. Further, a part of the steps may be performed at the same time as (in parallel to) another step.

The vehicle approach notification device according to one or more aspects has been described above based on the exemplary embodiment. However, the present invention is not limited to the exemplary embodiment. Configurations in which various modifications conceived by those skilled in the art are applied to the exemplary embodiment, and configurations established by combining constituent elements in different exemplary embodiments may also fall within the scope of one or more aspects, without departing from the scope of the present invention.

### INDUSTRIAL APPLICABILITY

The present disclosure is suitable for the vehicle approach notification device mounted on low-noise vehicles such as the electrically driven vehicle and the hybrid vehicle.

### REFERENCE MARKS IN THE DRAWINGS

10, 20, 30: vehicle approach notification device
11, 21, 31: sound source
12: filter
14, 24, 34: first amplifier
15, 25, 35: second amplifier
16, 26, 37: first speaker system
16a, 26a, 37a: first speaker
17, 27, 38: second speaker system
17a, 27a, 38a: second speaker
22, 32: first filter
23, 33: second filter
36: third amplifier
39: third speaker system
39a: third speaker
100, 110: vehicle

1. A vehicle approach notification device comprising:
a plurality of speakers;
a sound source configured to output a signal corresponding to one sound for making a notification about approach of a vehicle;
a plurality of amplifiers configured to be connected in series to the plurality of speakers, respectively, and amplify the signal; and
a filter configured to be connected in series to at least one of the plurality of amplifiers and modulate the signal,
wherein at least one of the plurality of speakers outputs a sound different from sounds to be output from other speakers of the plurality of speakers.

2. The vehicle approach notification device according to claim 1, wherein the filter is an amplitude modulator that modulates an amplitude of the signal.

3. The vehicle approach notification device according to claim 1, wherein the filter is a frequency modulator that modulates a frequency of the signal.

4. The vehicle approach notification device according to claim 1, wherein the filter is a phase modulator that modulates a phase of the signal.

5. The vehicle approach notification device according to claim 1, wherein the filter is a delay filter that delays output timing of the signal.
